(19) United States
(12) Patent Application Publication
(10) Pub. No.: US 2017/0287252 A1
(43) Pub. Date: Oct. 5, 2017

(54) Counterfeit Document Detection System and Method

(71) Applicants: Harshal Dwarkanath Laddha, Nashik (IN); Unmesh Dwarkanath Laddha, Marietta, GA (US)

(72) Inventors: Harshal Dwarkanath Laddha, Nashik (IN); Unmesh Dwarkanath Laddha, Marietta, GA (US)

(21) Appl. No.: 15/089,561

(22) Filed: Apr. 3, 2016

(51) Int. Cl. G07D 7/20; H04N 1/32; G06K 9/03; G06T 7/00; G06K 9/18

(52) U.S. Cl. CPC G07D 7/2016; G06T 7/0085; G06K 9/18; G06K 9/03; H04N 1/32309; G06T 2207/30176; G06T 2207/10024; G06T 2207/10008; G06T 2207/20021; G06K 2209/01; H04N 2201/327

(57) ABSTRACT

A system and method for detecting counterfeit document. The invention evaluates identifying the Region of Interest (ROI) where patterns such as VOID/COPY Pantographs are located; forming an image of the ROI; cropping the image of ROI; applying multichannel filtering for texture/pattern analysis; detecting object/edges; partitioning a group of data points into clusters; converting gray scale image to binary form using thresholding; applying motion blur to the binary image and further applying thresholding; determining bounding area of bounding boxes to make the identified characters machine readable for OCR. A counterfeit document is detected where the characters under pattern (e.g. VOID/COPY Pantograph) are not detected.

### BACKGROUND OF THE INVENTION

### 1. Technical Field

The present invention relates generally to detection and prevention of document fraud on the basis of the image of the document received from sources like mobile phone camera, scanners etc. More particularly, the invention relates to a counterfeit document detection system and method which can be used for any documents like check, healthcare records etc.

### 2. Related Art

With the rapid changes and advancement in the document creating, scanning and copying technology, the problems relating to fraudulent documents have increased dramatically. To mitigate the risks and frauds pertaining to fraudulent document creation, scanning and copying, technology has been created that evaluates checks, healthcare records etc. for counterfeiting based on security techniques built into these documents. E.g. VOID/COPY Pantograph configured in a background of a check can prevent fraudulent copying.

The current counterfeit detection and prevention processes available today are not adequate to detect the document frauds carried out by scanning and editing of the images using sophisticated and high resolution scanners and printers. They are mostly evaluated manually which does not provide enough protection to the users. The advancement in document alteration technology using editors like Photoshop, Corel Draw etc. oftentimes makes revisions of documents nearly impossible to catch. This is especially the case where the alteration can't be caught easily with naked eye.

Document processing in financial institutions, banks, insurance companies etc. is oftentimes automated to cater large volumes. The manual document evaluation as mentioned above for detecting counterfeit documents is a very difficult, costly, cumbersome, time consuming and inefficient way of document processing.

In view of the foregoing, there is a need in the art for a system and method for accurately and automatically detecting counterfeit documents.

In a first aspect of the invention is provided a method to identify the required Region of Interest (ROI) where the Pantograph is located, from the input image which is received from any image source like scanner, mobile device, image editors etc. The method comprising the steps of: ascertaining a specified area

a) having largest density of the minority pixels is determined and this region is further extracted out from the initial input image or

b) by shape or

c) by size/scale.

The ROI obtained from the above step is then cropped from the original image and the copped image is converted into Gray scale if not provided already in that form.

In a second aspect of the invention is provided a computer program product comprising a computer useable medium having computer readable program code embodied therein for applying multi-channel filtering on the image obtained in above step for texture analysis. The main issues involved in the multi-channel filtering approach to texture analysis are:

1) Functional characterization of the channels and the number of channels.

2) Extraction of appropriate texture features from the filtered images.

3) The relationship between channels (dependent vs. independent).

4) Integration of texture features from different channels to produce a segmentation.

Each (selected) filtered image is subjected to a bounded nonlinear transformation that behaves as a ‘blob detector’. The combination of multi-channel filtering and the nonlinear stages can be viewed as performing a multi-scale blob detection. Texture discrimination is associated with differences in the attributes of these blobs in different regions. A statistical approach is then used where the attributes of the blobs are captured by texture features defined by a measure of “energy” in a small window around each pixel in each response image. This process generates one ‘feature image’ corresponding to each filtered image (see FIG. 1). The size of the window for each response image is determined using a simple formula involving the radial frequency to which the corresponding filter is tuned.

In a third aspect of the invention is provided a computer program product comprising a computer useable medium having computer readable program code embodied therein for edge or object detection. Edge/object detection is the process of localizing pixel intensity transitions. The method uses the derivative approximation to find edges/objects. Therefore, it returns edges at those points where the gradient of the considered image is maximum. Derivative based approaches can be categorized into two groups, namely first and second order derivative methods. First order derivative based techniques depend on computing the gradient several directions and combining the result of each gradient. The value of the gradient magnitude and orientation is estimated using two differentiation masks, one vertical and one horizontal.

In a fourth aspect of the invention is provided a computer program product comprising a computer useable medium having computer readable program code embodied therein for partitioning a group of data points into a small number of clusters. The main issues involved in clustering are, first decide the number of clusters then a) Initialize the center of cluster b) attribute closest cluster to each data point c) Set the position of each cluster to the mean of all data points belonging to that cluster d) Repeat steps b-c until convergence.

The algorithm stops when the assignments do not change from one iteration to the next.

At this stage the characters hidden under Pantograph are visible on the image with naked eyes. If it's a counterfeit document created by scanning the original document and/or photo editing using photo editing software like Adobe Photoshop, Corel Draw etc. the image obtained will not display any characters. If there are characters present, then it is determined that the document is a genuine or a counterfeit photocopy document created using sophisticated high end photo copiers/printers.

In a fifth aspect of the invention is provided a computer program product comprising a computer useable medium having computer readable program code embodied therein for converting the image obtained in the above step to binary image by thresholding. The image is then applied with motion blur. Thresholding is applied again on the output image obtained after motion blur. These steps are repeated to get desired image output till no further iterations are possible. If the document is a genuine document, the image will display the characters hidden under Pantograph which can be viewed with naked eyes. If the document is a counterfeit document, no characters will be visible.

In a sixth aspect of the invention is provided a computer program product comprising a computer useable medium having computer readable program code embodied therein to determine if the document is genuine or counterfeit photocopy and make the characters machine readable using OCR. In order to achieve that, bounding boxes are drawn on the image obtained in the above step to detect the blobs. By calculating the bounding area of bounding boxes, it is determined which bounding boxes are to be considered for the purpose of the confirmation of the genuine or counterfeit and the automation of character reading using OCR. In case of the image of genuine document, we get large size blobs e.g. size greater than 7000, which are then considered and bounding boxes are drawn and the gaps are filled to make the boxes ready for OCR reading. The letters/characters are detected and read using OCR and they are returned to the image. In case of a counterfeit photocopy document, we won't get the blobs of large size. When the bounding boxes are drawn, and parsed to the OCR engine, it will not return in proper characters confirming that the document is a counterfeit photocopy document.

The foregoing and other features and advantages of the invention will be apparent from the following more particular description of preferred embodiments of the invention.

### BRIEF DESCRIPTION OF THE DRAWINGS

The preferred embodiments of this invention will be described in detail, with reference to the following figures, wherein like designations denote like elements, and wherein:

FIG. 1 shows the block diagram of document processing system including counterfeit document detection and prevention system in accordance with the invention.

FIG. 2 shows an exemplary document in the form of a check obtained from an image source like scanner, mobile camera/phone camera device etc.

FIG. 3 shows the cropped image of required ROI obtained a) which has largest density of the minority pixels and this region is further extracted out from the initial input image or b) by shape or c) by size/scale.

FIG. 4 shows the overview of texture segmentation algorithm.

FIG. 5 shows image obtained a) after multi-channel filtering for texture analysis, b) after applying the algorithm to detect the edges/object and c) after clustering

FIG. 6 shows the image obtained after binarization

FIG. 7 shows the image obtained after applying the motion blur

FIG. 8 shows the image with bounding boxes

FIG. 9 shows the image with letters detected with the OCR.

### DETAILED DESCRIPTION OF THE PREFERRED EMBODIMENTS

Although certain preferred embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., which are disclosed simply to describe the preferred embodiment.

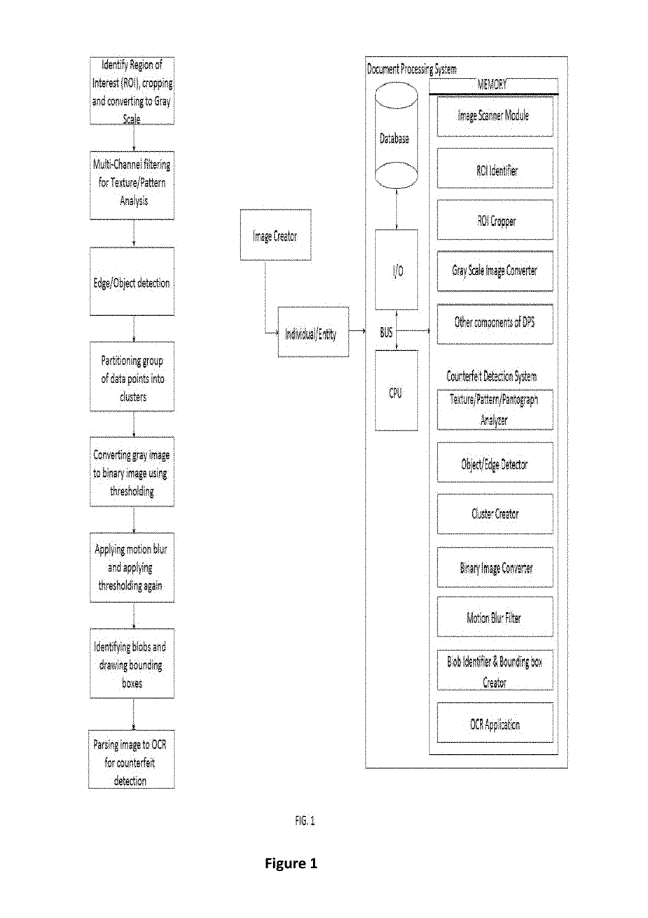

FIG. 1 is a block diagram of a document processing system including a counterfeit detection and prevention system in accordance with a preferred embodiment of the present invention. A document is generally processed by an individual or entity. For purposes of the present invention, an exemplary document that may be processed is a check. It should be recognized, however, that the present invention finds applicability relative to any document that may be counterfeited.

System preferably includes a memory, a central processing unit (CPU), input/output devices (I/O) and a bus. A database may also be provided for storage of data relative to processing tasks. Memory preferably includes a program product that, when executed by CPU, comprises various functional capabilities described in further detail below. Memory (and database) may comprise any known type of data storage system and/or transmission media, including magnetic media, optical media, random access memory (RAM), read only memory (ROM), a data object, etc. Moreover, memory (and database) may reside at a single physical location comprising one or more types of data storage, or be distributed across a plurality of physical systems. CPU may likewise comprise a single processing unit, or a plurality of processing units distributed across one or more locations. I/O may comprise any known type of input/output device including a network system, modem, keyboard, mouse, document scanner, check scanner, mobile phone, voice recognition system, CRT, printer, disc drives, etc. Additional components, such as cache memory, communication systems, system software, etc., may also be incorporated into system.

Document processing system may be implemented in a variety of forms. For example, document processing system may be a high speed, high volume document processing system such as found in institutional banks or a single or multiple item(s) processing using mobile phones etc. System, as recognized in the field, may include one or more networked computers, i.e., servers. In this setting, distributed servers may each contain only one application/system/module with the remainder of the applications/systems/modules resident on a centrally located server. In another embodiment, a number of servers may be present in a central location, each having different software applications resident therein. A server computer typically comprises an advanced midrange multiprocessor-based server, utilizing standard operating system software, which is designed to drive the operation of the particular hardware and which is compatible with other system components, and I/O controllers.

Alternatively, system may be implemented as a workstation such as a bank teller workstation. A workstation of this form may comprise, for example, an INTEL PENTIUM Core i5 or AMD microprocessor, or like processor, such as found in an IBM, Lenovo, Dell PCs.

Memory of system preferably includes a program product that, when executed by CPU, provides various functional capabilities for system. As shown in FIG. 1, program product may include an image scanning and processing module, a gray scale converter to convert images to gray scale, black-white converter for converting images to black and white, and other document processing system (DPS) component(s). Other DPS components may include any well-known document processing system components, e.g., an image capture processor. In accordance with a preferred embodiment of the invention, program product also may provide, or include, a Counterfeit detection system. Counterfeit detection system includes a multi-channel filter, an object/edge detection filter, a clustering and a motion blur filter and an OCR engine.

In the following discussion, it will be understood that the method steps discussed preferably are performed by a processor, such as CPU of system, executing instructions of program product stored in memory. It is understood that the various devices, modules, mechanisms and systems described herein may be realized in hardware, software, or a combination of hardware and software, and may be compartmentalized other than as shown. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after the following: (a) conversion to another language, code or notation; and/or (b) reproduction in a different material form.

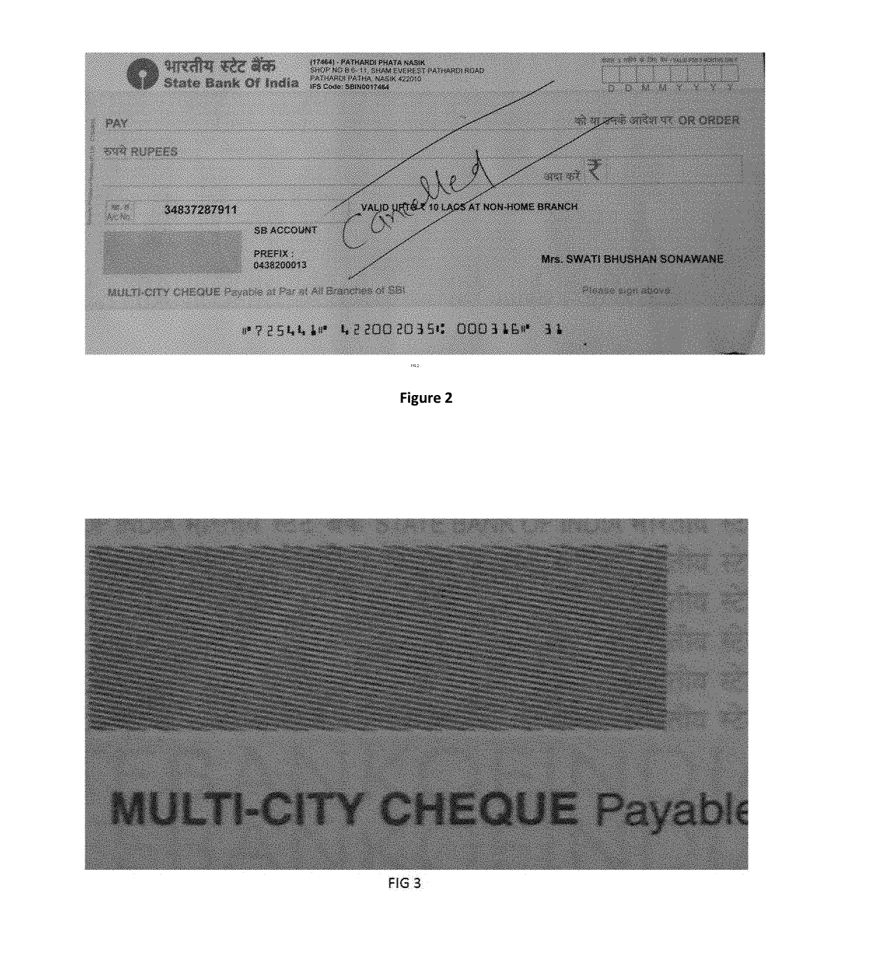

Turning to FIG. 2, a document in an exemplary form of a check is shown. Document includes a number of fields.

As shown in an exemplary cropped ROI image in FIG. 3 it has a predetermined pattern/texture. In a preferred embodiment, a predetermined pattern is recognized by shape, Size & Scale or area having largest density of minority pixels. However, other measurement mechanisms for ROI may be possible. Each ROI may have any geometric pattern. For reasons that will become apparent below, a high density pattern/texture, is preferred because it provides higher detection reliability.

It should be recognized that while the present invention will be described relative to a document having pre-set texture/pattern, the invention is equally applicable to a document having a complete different background. In this situation, other methods for determining a specific Region of Interest are used.

In exemplary check, Region of Interest (ROI) include a Pantograph area as shown in FIG. 3. The Pantograph pattern may have any textual or numerical matter.

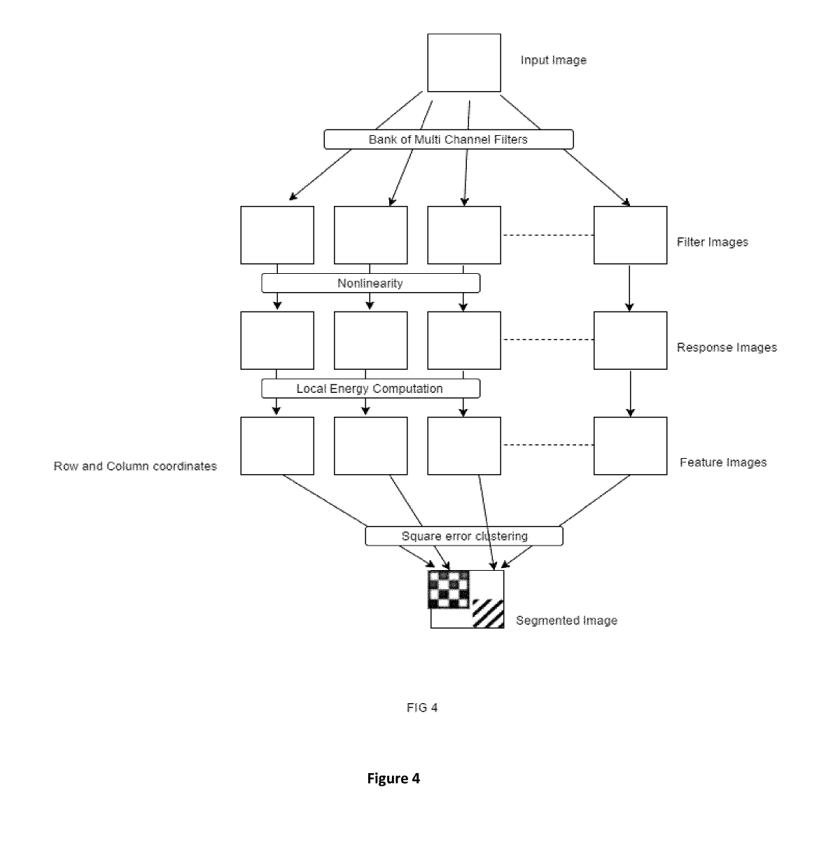

Referring to FIGS. 4-6, the logic of detecting counterfeit document using counterfeit detection system will be described in more detail. Precursor steps to the logic of FIG. 4 may preferably include: 1) imaging document, i.e., converting the document into a digital form when document is not already provided in that form; and/or 2) converting the image to Gray Scale image when document is not already provided in that form; and identification of document.

Imaging of document may be provided by an image scanner module of system or some other separate imaging system e.g. check scanner or mobile phone camera etc. Conversion of that image to a gray scale image is preferably conducted by a gray scale converter of system. A document identification is preferably gathered from each document by a document identifier. As known in the art, document may include an identification thereon so system may ascertain a variety of information about document. For instance, system can evaluate whether document is of a type for which evaluation is desired. In addition, if evaluation is desired, system can determine, inter alia, Region of Interest (ROI) on document and their respective predetermined pattern(s). For example, for check, the identification may indicate a rectangular box of Pantograph. Document information such as location of ROI present on document, etc., may be obtained by system from database, which may be subject to periodic updates. In one preferred embodiment, document processor periodically verifies predetermined patterns of ROI of documents used by document processor for use by system. Alternatively, if a system is used with a single type of document, document identification may be eliminated. In the case of check, an identification may be provided, for example, by some digits (FIG. 2) in the routing number.

Again referring to FIGS. 4-6, the logic of counterfeit detection system will be described in more detail. Counterfeit Detection system is capable of discovering counterfeit document, (FIG. 5) that remove the foreground texture/pattern in ROI. It displays the letters COPY/VOID. It confirms that the document is not a counterfeit document, in this case check, created by scanning the original document using high end, high resolution digital scanners etc. and altered/edited using software like Adobe Photoshop, Corel Draw etc. and then edited image is printed using digital and high resolution printers to create counterfeit document.

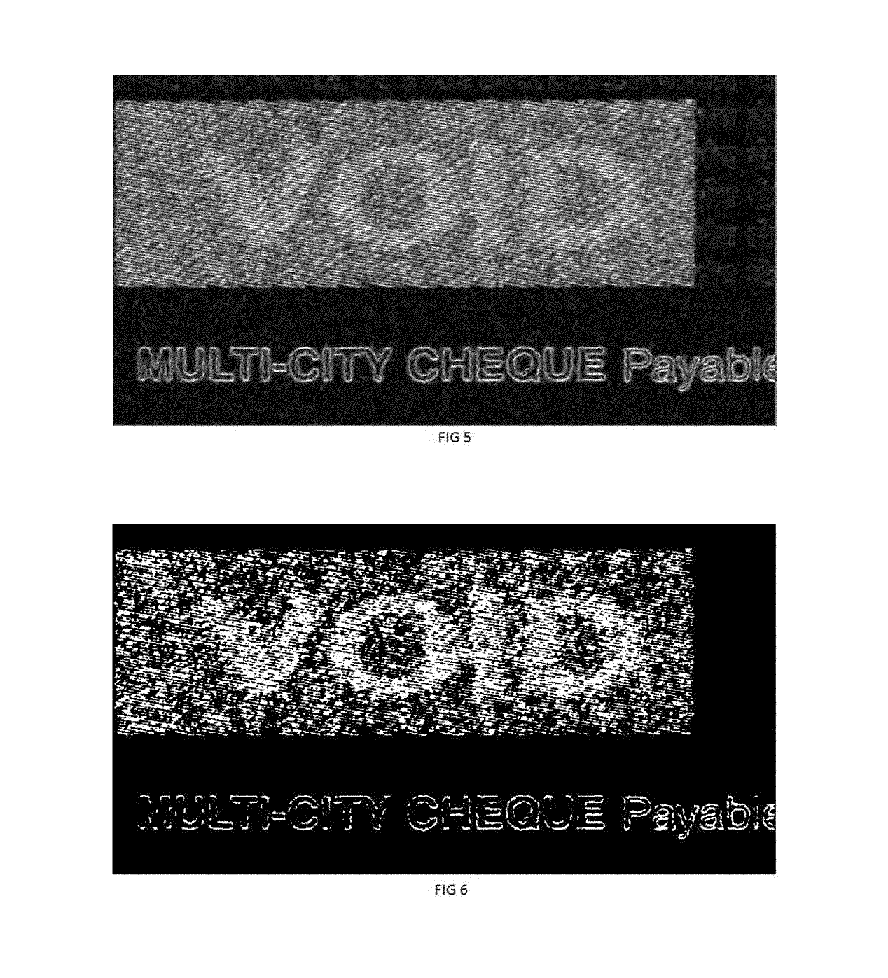

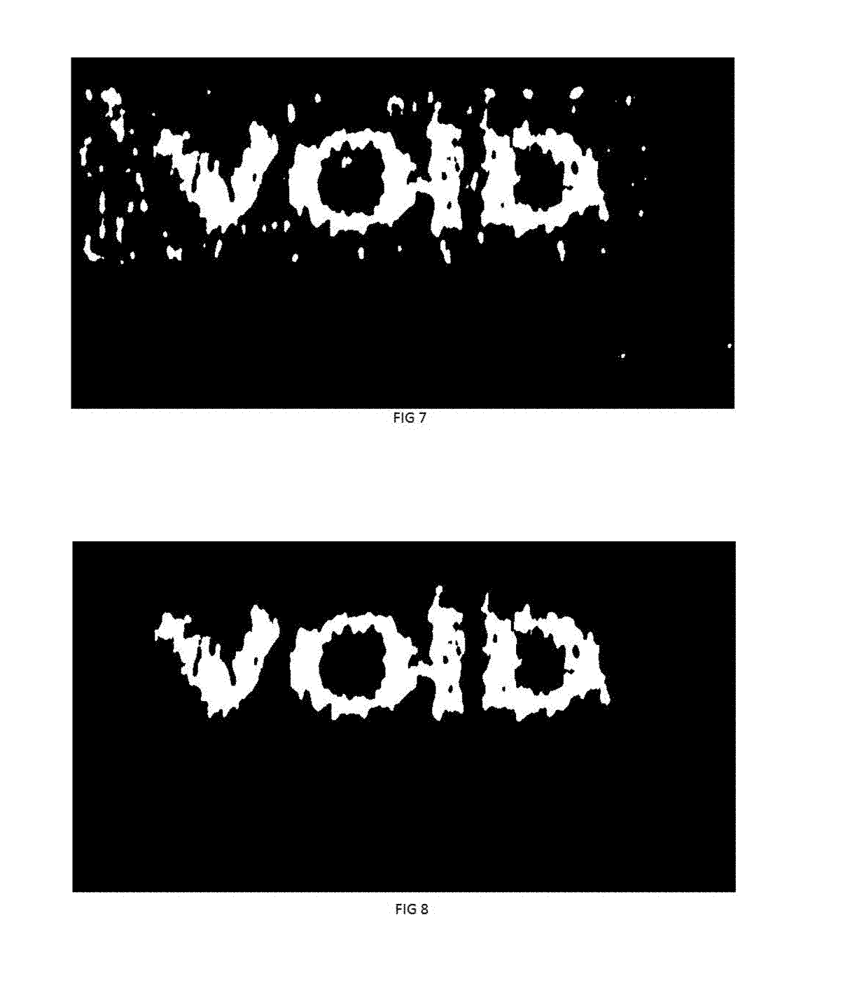

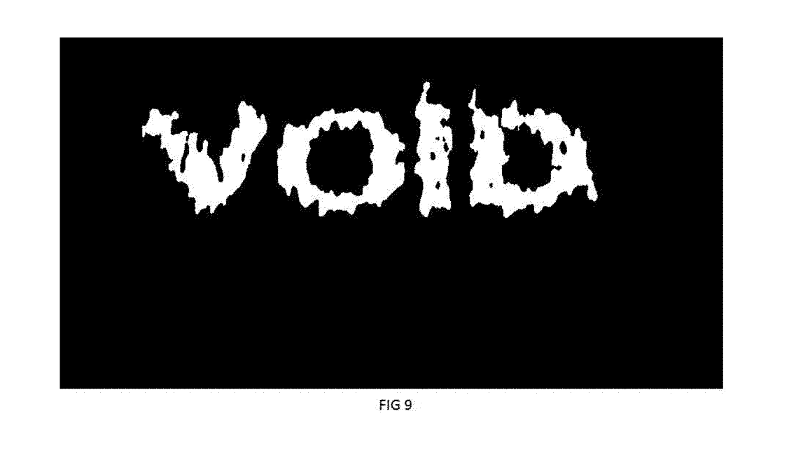

Now, the document either is a genuine document or it is a counterfeit document created by photocopying of the of the original document, done with high end, high resolution, sophisticated digital photo copier. To detect the counterfeit, the image obtained in above step is converted to a binary form using thresholding (FIG. 6) and applying the motion blur effect to the image (FIG. 7). Thresholding is applied further to refine the results, till no further iterations are possible. If the document is a genuine document, the image will display the characters e.g. COPY/VOID hidden under Pantograph which can be viewed with naked eyes. If the document is a counterfeit document, no characters will be visible. To make the counterfeit detection process automated, and make the characters machine readable using OCR, bounding boxes are drawn on the image obtained in the above step to detect the blobs. By calculating the bounding area of bounding boxes, it is determined which bounding boxes are to be considered for the purpose of the confirmation of the genuine or counterfeit and the automation of character reading using OCR. In case of the image of genuine document, we get large size blobs e.g. size greater than 7000, which are then considered and bounding boxes are drawn and the gaps are filled to make the boxes ready for OCR reading. The letters/characters are detected and read using OCR and they are returned to the image. In case of a counterfeit photocopy document, we won't get the blobs of large size. When the bounding boxes are drawn, and parsed to the OCR engine, it will not return any proper characters confirming that the document is a counterfeit photocopy document.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A method of detecting counterfeit document created by color copying the original document using normally available or high end, high resolution specialized printers or by scanning the original document using normally available or high end, high resolution sophisticated scanners and then printing the image of the document using high end, high resolution or normal printers, having a field of predetermined pattern(s) such as COPY/VOID Pantographs, the method comprising the steps of:
ascertaining a Region of Interest forming an image of ROI by cropping the area where the pattern/Pantograph is located and converting the cropped image to Gray scale if the original input image is not already in that form;
applying multi-channel filtering on the gray scale image for patter/texture analysis;
identifying the edges/objects;
partitioning a group of data points into a small number of clusters;
converting gray scale image to binary image by thresholding;
applying motion blur to the binary image and further applying thresholding;
drawing the bounding boxes to detect blobs;
calculating the bounding area of bounding boxes;
determining which bounding boxes are to be considered for the purpose of the confirmation of the genuine or counterfeit and do automatic character reading using OCR.
wherein a counterfeit document is indicated when no characters in the image are visible by naked eyes and/or read by the OCR.

2. The method of claim 1, wherein the steps of ascertaining a Region of Interest include identifying a specified area with pattern/texture or Pantograph by ascertaining a specified area.

3. The method of claim 2, further comprising the step of ascertaining a Region of Interest (ROI) by identifying a specified area a) having largest density of the minority pixels is determined and this region is further extracted out from the initial input image or b) by shape or c) by size/scale.

4. The method of claim 1, wherein the step of forming an image of the ROI includes cropping of the part of the original input image having the specified area as obtained and converting it to Gray scale if the original image is not provided already in that form.

5. The method of claim 1, wherein the steps of analyzing the pattern/texture or Pantograph includes applying multi-channel filtering to the gray scale image of ROI.

6. The method of claim 5, further comprising the steps of doing texture/pattern analysis include 1) functional characterization of the channels and the number of channels, 2) extraction of appropriate texture features from the filtered images. 3) the relationship between channels (dependent vs. independent), and 4) integration of texture features from different channels to produce a segmentation.

7. The method of claim 1, wherein the step of identifying the edges/objects include the process of localizing pixel intensity transitions where derivative approximation is used to find edges/objects.

8. The method of claim 1, wherein the step involved in clustering includes partitioning a group of data points into a small number of clusters.

9. The method of claim 8, further comprising the steps of deciding the number of clusters include a) Initializing the center of cluster b) attributing closest cluster to each data point c) Setting the position of each cluster to the mean of all data points belonging to that cluster d) Repeating steps b-c until convergence.

10. The method of claim 1, wherein the image obtained after Clustering is converted to binary image by thresholding.

11. The method of claim 1, wherein the image obtained after applying thresholding is applied with motion blur function and thresholding is applied again on to that image.

12. The method of claim 1, wherein the image obtained would have the characters under Pantograph (COPY/VOID) and which can be read by naked eyes or using an OCR application automatically. In order to make the image OCR readable, bounding boxes are drawn on the image obtained to detect the blobs. Bounding boxes are drawn by calculating the bounding area. Bounding boxes having large size of blobs are parsed to the OCR application after filling the gaps.
The letters/characters are detected and read using OCR and they are returned to the image. In case of a counterfeit photocopied/scanned document, we won't get the blobs of large size. When the bounding boxes are drawn, and image is parsed to the OCR engine, it will not return in proper characters confirming that the document is a counterfeit photocopy/scan document.

13. A system for detecting counterfeit documents having a predetermined pattern/Pantograph, the system comprising:
an imager for converting an image to gray scale if not provided in the same format
an imager for forming image of the Region of Interest (ROI)
an image cropper for cropping the ROI;
a pattern/texture/pantograph analyzer comprising multi-channel filter which 1) does functional characterization of the channels and the number of channels, 2) does extraction of appropriate texture features from the filtered images. 3) identifies the relationship between channels (dependent vs. independent), and 4) does integration of texture features from different channels to produce a segmentation thereon;
an edge/object detector which uses the derivative approximation/localizing pixel intensity transitions to find edges/objects;
a cluster creator for partitioning a group of data points into a small number of clusters by deciding the number of clusters, then a) Initializing the center of cluster b) attributing closest cluster to each data point c) Setting the position of each cluster to the mean of all data points belonging to that cluster d) Repeating steps b-c until convergence thereon;
an image converter to convert the gray scale image to binary (Black & White) format using thresholding;
an imager to apply motion blur to the binary image;
an imager to identify the blobs and drawing bounding boxes and filling the gaps to make the image machine readable using OCR;

14. The system of claim 13, wherein the document includes a predetermined pattern/texture/Pantograph.

15. A document processing system comprising the system for indicating counterfeit documents having predetermined pattern/texture/Pantograph.

16. A workstation comprising the system for detection of counterfeit documents having predetermined pattern/texture/Pantograph.

17. A computer program product comprising a computer useable medium having computer readable program code embodied therein for indicating counterfeit document; where document is having a predetermined pattern/texture/Pantograph, the computer program product comprising:
program code configured to identify a specified area a) having largest density of the minority pixels b) by shape or c) by size/scale;
program code configured to crop the specified area/Region of Interest (ROI) to form an image of the ROI;
program code configured to convert image to gray scale if the original image is not provided in the format already;
program code configured to analyze the pattern/texture/Pantograph with multi-channel filtering by doing:
1) functional characterization of the channels and the number of channels,
2) extraction of appropriate texture features from the filtered images.
3) identification the relationship between channels (dependent vs. independent), and
4) integration of texture features from different channels to produce a segmentation thereon;
program code configured to detect edges/object by localizing pixel intensity transitions thereon;
program code configured to partition a group of data points into a small number of clusters then a) Initialize the center of cluster b) attribute closest cluster to each data point c) Set the position of each cluster to the mean of all data points belonging to that cluster d) Repeat steps b-c until convergence. thereon;
program code configured to convert the gray scale image to binary format using thresholding;
program code to apply motion blur to the binary image;
program code to identify blobs and drawing bounding boxes by determining bounding area and parsing the image to the OCR application to read the characters automatically;
wherein a counterfeit document is indicated where the characters under pattern (e.g. VOID/COPY Pantograph) are not detected.
